(19) United States
(12) Patent Application Publication
(10) Pub. No.: US 2013/0201594 A1
(43) Pub. Date: Aug. 8, 2013

(54) DRIVING CIRCUIT FOR RELAY

(71) Applicants: Pao-Hung LIN, (US); Hung-Lung Wang, (US)

(72) Inventors: Pao-Hung LIN, (US); Hung-Lung Wang, (US)

(21) Appl. No.: 13/365,556

(22) Filed: Feb. 3, 2012

(51) Int. Cl. H01H 47/22

(52) U.S. Cl. 361/191

(57) ABSTRACT

The present invention relates to a driving circuit for relay, which uses N relays with their coils coupled to each other. One of the relays is coupled to a driving power supply. A switching control circuit is coupled to a second relay and a reference voltage for controlling on/off of the plurality of relays. A driving control circuit is coupled to the plurality of relays for controlling excitation of the plurality of relays. After the coils of the relays are excited by the driving control circuit, the voltage of a single coil is dropped to one Nth of the driving voltage. Thereby, the power consumption of the coils of the relays can be reduced, and hence enhancing the lifetime and reliability of the relays.

### FIELD OF THE INVENTION

The present invention relates generally to a driving circuit, and particularly to a driving circuit for relay.

### BACKGROUND OF THE INVENTION

In some specific applications, based on safety concern, it is required to open the output circuit and an electronic device completely. Taking the grid-connected photovoltaic power system as an example, because the output of the power system is parallel with the grid, when there is safety concern or the power system fails, the power system must be isolated form the grid rapidly. Thereby, the parallel switching device between the power system and the grid needs to have the capability of opening the live wire and the earth wire simultaneously and providing sufficient electrical isolation for avoiding danger on the system and people.

Accordingly, current vendors provide relays to solve the problem described above. Relays can provide sufficient impedance for insulation. Besides, in compared with semiconductor electrical switches, they also have higher operational stability and reliability. In some international safety regulations, mechanical relays are even mandatory safety devices. In considering redundancy for safety, two sets of protection circuits are required. They can open the live wire of the grid as well as the earth wire at the same time independently. Taking a single-phase system for example, four relays are required. As for a three-phase system, twelve relays are necessary. Thereby, the characteristics of a relay usually determine the lifetime and reliability of a system. The key point lies on the power consumption and the operating temperature of coil.

At present, there are many methods for reducing the power consumption of relays. The first method is to use series resistors to the coil of a relay for lowering the coil voltage. The principle is that at the moment when the coil of the relay starts to be turned on, because the capacitor voltage has not been established, the coil voltage will be equal to the driving voltage. Then, as the capacitor voltage increases, the coil voltage reduces accordingly until the voltage and current are balanced and have reached a steady state. At this time, the coil voltage will be equal to the driving voltage minus the voltage across the resistor. Thanks to the reduction of coil voltage, the power consumption of the relay can be lowered. Considering circuit design, the value of the resistor is a trade-off between the minimum holding voltage of the coil, namely, the lowest voltage for the relay to maintain closed, and the power consumption of the coil. When the resistor is larger, the coil voltage will smaller. Excessively low coil voltage makes the contact impedance of the reed larger or even opens the contact. Although this method is simple, there is still a wear problem on the resistors. Accordingly, this method only improves the power consumption of relays. It is not beneficial for improving the overall wear of the system.

The second method for reducing the power consumption of coil is achieved by adding a lower holding voltage from exterior. As the assumption described above, the capacitor will have no charge before conduction of a relay. Thereby, at the transient when the relay is turned on by a driving signal, the coil voltage is equal to the driving voltage. This voltage, which is higher than the holding voltage, will drive the relay to turn on rapidly. Subsequently, the capacitor stores energy gradually. The coil voltage drops gradually until it is clamped by the holding voltage. The holding voltage must be higher than the minimum holding voltage of the coil for keeping the contact of the relay closed. In comparison with the first method of driving by series resistors, this method has no resistor wear problem but just needs to maintain the voltage level. Nonetheless, its drawback is that an extra set of power supply will increase the cost and complexity of circuits.

Another driving method for reducing power consumption is to add a high-frequency switch in the original driving circuit. If the ratio of the turn-on time of the high-frequency switch to the switching period is defined as the duty cycle, changing the duty cycle is equivalent to changing the driving current of a relay. Thereby, by lowering the average driving current, the purpose of reducing the power consumption can be achieved. Although this driving method is simple and easy for adjustment, a high-frequency signal generating circuit is required. Hence, the cost and complexity of the circuit is increased.

Accordingly, the present invention provides a driving circuit for relay, which improves the problems in the driving circuit according to the prior art. According to the present invention, the circuit complexity is reduced, the power consumption of the coil of a relay is lowered, and the lifetime and reliability of a relay is enhanced.

### SUMMARY

An objective of the present invention is to provide a low-power driving circuit for relay. By using the method according to the present invention, the coil voltage can be reduced and hence lowering the power consumption and operating temperature of relays. Thereby, the purposes of enhancing the lifetime and reliability of relays can be achieved.

The present invention provides a driving circuit for relays, which comprises a plurality of relays, a switching control circuit, and a driving control circuit. The coils of the plurality of relays are coupled to a power supply, and the coils of the plurality of relays are coupled to each other. The switching control circuit is coupled to a second relay and a reference voltage level, and controls on/off of the plurality of relays according to a driving signal. The driving control circuit is coupled to and controls the excitation state (current passing through the coils and generating magnetic field) of the plurality of relays. By taking advantage of the property that when the coils of N relays are connected in series with the driving power supply the driving voltage will be uniformly distributed to the coils of the relays, the voltage level of the coil of a single relay will be equal to one Nth of the driving voltage, where N is the number of the plurality of relays. Thereby, the power consumption in the excitation coils of relays can be lowered, and hence enhancing their lifetime and reliability.

### BRIEF DESCRIPTION OF THE DRAWINGS

FIG. 1A shows a circuit diagram according to an embodiment of the present invention;

FIG. 1B shows a waveform diagram according to an embodiment of the present invention;

FIG. 2A shows a circuit diagram according to another embodiment of the present invention;

FIG. 2B shows a waveform diagram according to another embodiment of the present invention;

FIG. 3A shows a circuit diagram according to another embodiment of the present invention; and

FIG. 3B shows a waveform diagram according to another embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

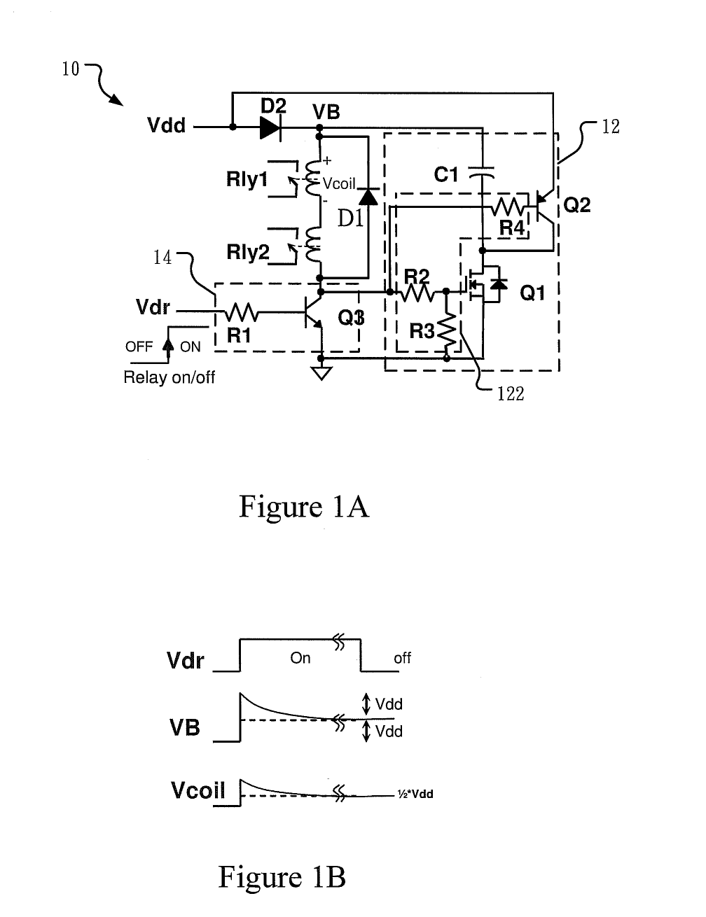

FIGS. 1A and 1B show a circuit diagram and a waveform diagram according to an embodiment of the present invention. As shown in the figures, the driving circuit for relay 10 comprises a plurality of relays, a driving control circuit 12, and a switching control circuit 14. According to the present embodiment, the plurality of relays include a first relay Rly1 and a second relay Rly2. The driving control circuit 12 includes a first switching unit Q1, a second switching unit Q2, a capacitor C1, and a bias unit 122. The bias unit 122 includes a plurality of resistors R2, R3, R4. The switching control circuit 14 includes a third switching unit Q3 and a resistor R1. In addition, the driving circuit 10 according to the present embodiment further comprises a first diode D1 and a second diode D2.

The anode of the second diode D2 and a third terminal (emitter) of the second switching unit Q2 are connected to the driving power supply Vdd. The coils of the first and second relays Rly1, Rly2 are connected in series. The first relay Rly1 is coupled to the cathode of the second diode D2 and the capacitor C1. The second relay Rly2 is connected to a reference voltage level, which is the ground level according to the present embodiment, through the third switching unit Q3 for achieving the function of serial driving. The driving control circuit 12 is coupled to the first and second relays Rly1, Rly2. The capacitor C1 is coupled to the first relay Rly1 and a second terminal (drain) of the first switching unit Q1. The resistors R2, R3 of the bias unit 122 are coupled to the switching control circuit 14, namely, a third terminal (collector) of the third switch unit Q3. A first terminal (gate) of the first switch unit Q1 is coupled to the resistor R3 of the bias unit 122 and the reference voltage level. A first terminal of the second switch unit Q2 is coupled to the resistor R4 of the bias unit 122. A second terminal (collector) of the third switch unit Q3 is coupled to the second relay Rly2. A second terminal (collector) of the second switch unit Q2 is coupled between the capacitor C1 and the first switch unit Q1.

The switching control circuit 14 is coupled to the second relay Rly2 and a reference voltage level, and controls on/off of the first and second relays Rly1, Rly2 according to a driving signal Vdr. One terminal of the resistor R1 receives the driving signal Vdr and other terminal thereof is coupled to a first terminal (base) of the third switch unit Q3. The second terminal (collector) of the third switch unit Q3 is coupled to the second relay Rly2. A third terminal (emitter) of the third switch unit Q3 is coupled to the reference voltage level. Besides, the driving control circuit 12 according to the present embodiment is a voltage doubler circuit. The bias unit 122, the first switch unit Q1, the second switch unit Q2, and the capacitor C1 use the charge pump principle to increase the transient driving voltage to double of the driving voltage Vdd. In other words, the transient voltage at the node VB is double of the driving voltage Vdd.

Furthermore, the first diode D1 is a freewheeling diode with one terminal coupled to the coil of the first relay Rly1 and the other terminal coupled to the coil of the second relay Rly2 for providing a path for the first and second relays Rly1, Rly2 to release the stored energy at the cutoff transient and thus avoiding burnout of the third switch unit Q3, which is caused by the high voltage produced by the energy of the transient current di/dt of the coil exceeding the voltage rating of the third switch unit Q3. The second diode D2 is a blocking diode with one terminal coupled to the driving power supply Vdd and the driving control circuit 12 and the other terminal coupled to the first relay Rly1. The function of the second diode D2 is to isolate the driving voltage Vdd from the first and second relays Rly1, Rly2 by the driving control circuit 12 during the transient driving period.

Before the driving signal Vdr is generated, the voltage of the driving signal Vdr is kept at low voltage level. When the third switch unit Q3 is cut off, the coils of the first and second relays Rly1, Rly2 cannot form a circuit for the driving voltage Vdd and the circuit is regarded open. The voltage of the collector of the third switch unit Q3 is equal to the driving voltage Vdd. The first switch unit Q1 is turned on by means of the resistors R2, R3 of the bias unit 122. Thereby, the driving voltage Vdd will form a circuit via the second diode D2, the capacitor C1, and the first switch unit Q1. The driving voltage Vdd will store energy in the capacitor C1 until the voltage of the capacitor C1 is equal to the driving voltage level Vdd. During the turn-on period of the first switch unit Q1, the high voltage level at the drain of the third switch unit Q3 cuts off the second switch unit Q2. After the capacitor C1 completes storing energy, all devices are maintained at the cutoff state. At this time, the driving circuit 10 will have no power consumption.

When the driving signal Vdr is changed form the low voltage level to the high level, the third switch Q3 will be turned on. At this moment, the voltage of the drain of the third switch Q3 reduces gradually from the original deriving voltage level Vdd to the saturation voltage Vce(sat) of the third switch Q3. With the matched resistors R2, R3, R4 of the bias unit 122, when the third switch unit Q3 is on, the degree of conduction of the first switch unit Q1 reduces gradually and that of the second switch unit Q2, which is originally cut off, increases gradually until the first switch unit Q1 is cut off completely and the second switch unit Q2 is turned on completely. At this time, the second switch unit Q2 is in the saturation state. The emitter-to-collector voltage of the second switch unit Q2 Vec is maintained at the saturation voltage Vec(sat), which is 0.2-0.3V. According the circuit relation, it is known that the drain voltage of the second switch unit Q2 is Vdd−Vec(sat). As the description above, the steady-state voltage of the capacitor C1 in the previous state is Vdd.

As shown in FIG. 1B, at the transient when the driving signal Vdr is changed form the low level to the high, the node voltage VB will be equal to the steady-state voltage of the capacitor C1 plus the drain voltage of the second switch unit Q2 and becomes 2Vdd−Vec(sat). If the saturation voltage is ignored, the node voltage VB will be equal to double of the driving voltage Vdd. Because the coil is connected to the ground via the third switch unit Q3 connected in series, at the turn-on transient, the coil voltage Vcoil of the first and second relays Rly1, Rly2 is approximately equal to the driving voltage Vdd. In circuit design, the selection of the driving voltage Vdd has to be greater than or equal to the threshold voltage for the excitation coil to act, namely, the voltage sufficient to excite the coils of the relays and close the contact, thereby the coils of the first and second relays Rly1, Rly2 can be excited to close the reeds. The function of the second diode D2 is to isolate the energy of the blocking capacitor C1 from pouring back to the power supply Vdd. During the cutoff period of the second diode D2, the energy stored in the capacitor C1 is released continuously to the first and second relays Rly1, Rly2. As the energy released by the capacitor C1 reduces continuously, the node voltage VB reduces gradually as well until the completion of energy release of the capacitor C1. Then, the second diode D2 will enter the conduction state. Meanwhile, the node voltage VB is approximately equal to the driving voltage Vdd. If the saturation voltage of the third switch unit Q3 is ignored, the coil voltage Vcoil of the first and second relays Rly1, Rly2 are both equal approximately to Vdd/2. Afterwards, the driving circuit enters the steady state. The third switch unit Q3 maintains turned on while the second and first switch units Q2, Q1 cutoff. At this time, the driving control circuit 12 will have no power consumption. In circuit design, it is required to make sure that Vdd/2 is greater or equal to the minimum holding voltage of the relays for keeping conduction of the contacts of the relays until the state of the driving signal Vdr is changed. Then, the actions described above will be repeated. Thereby, the steady-state power consumption, and hence the temperature, of the coils of the relays Rly1, Rly2 can be reduced. The lifetime and reliability of relay can be enhanced accordingly.

In the above embodiment, two relays Rly1, Rly2 are used with their excitation coils connected in series. Accompanying the driving control circuit 12, namely, the voltage doubler circuit, the driving circuit of the relays Rly1, Rly2 is achieved. Nonetheless, based on the same essence, the present embodiment can be extended to the applications of a single or a plurality of excitation coils connected in series.

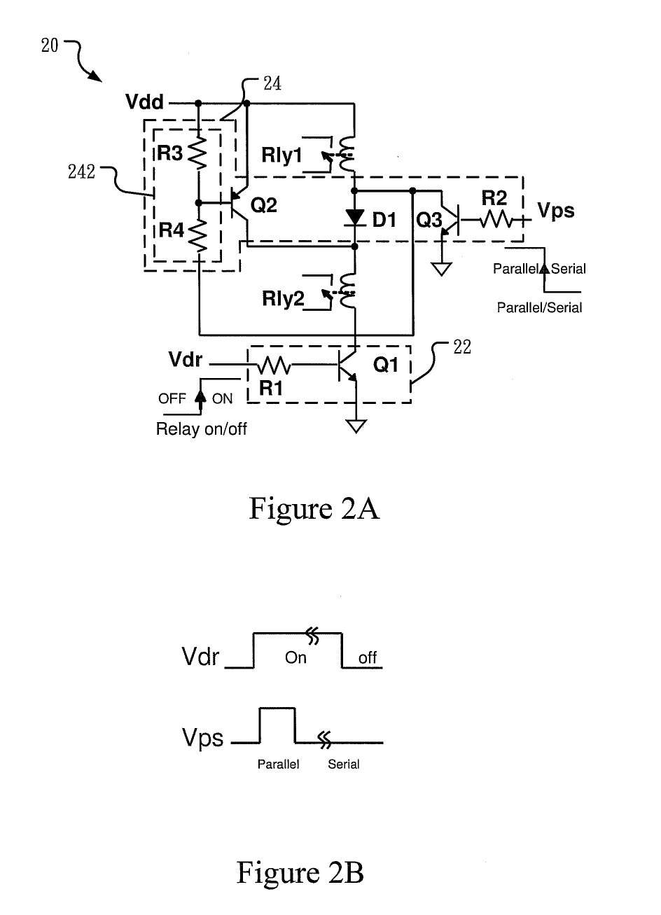

FIGS. 2A and 2B show a circuit diagram and a waveform diagram according to another embodiment of the present invention. As shown in the figures, the driving circuit for relay 20 according to the present invention comprises a first relay Rly1, a second relay Rly2, a switching control circuit 22, and a driving control circuit 24. The switching control circuit 22 includes a first switching unit Q1 and a resistor R1. The driving control circuit 24 includes a second switching unit Q2, a third switching unit Q3, a bias unit 242, and a resistor R2. The bias unit 242 includes a plurality of resistors R3, R4. In addition, the driving circuit 20 according to the present embodiment further comprises a first diode D1.

The first relay Rly1 receives the driving voltage Vdd of the power supply. The second relay Rly2 is coupled to the first relay Rly1. The switching control circuit 22 is coupled to the second relay Rly2 and a reference voltage and controls on/off of the first and second relays Rly1, Rly2 according to a driving signal Vdr. The resistor R1 is coupled to the driving signal Vdr. A first terminal of the first switch unit Q1 is coupled to the resistor R1. A second terminal of the first switch unit Q1 is coupled to the second relay Rly2. A third terminal (emitter) of the first switch unit Q1 is coupled to a reference voltage. Thereby, the first switch unit Q1 controls on/off of the first and second relays Rly1, Rly2 according to the driving signal Vdr. The driving control circuit 24 is coupled to a first relay Rly1 and a second relay Rly2. One terminal of the resistor R3 of the bias unit 242 is coupled to the driving voltage Vdd. A first terminal (base) of the second switch unit Q2 is coupled between the resistors R3 and R4 of the bias unit 242. A second terminal of the second switch unit Q2 is coupled to the driving power supply Vdd and the first relay Rly1. A third terminal of the second switch unit Q2 is coupled to the second relay Rly2. A first terminal of the third switch unit Q3 receives a control signal Vps via the resistor R2. A second terminal of the third switch unit Q3 is coupled to the first relay Rly1 and the other terminal of the resistor R4 of the bias unit 242. A third terminal of the third switch unit Q3 is coupled to the reference voltage. Besides, the second and third switch units Q2, Q3 drive the first and second relays Rly1, Rly2 according to the control signal Vps and form a serial or parallel circuit.

The first relay Rly1, the first diode D1, the second relay Rly2, and first switch unit Q1 are connected electrically in series. In addition, the first diode D1 is connected between the first and second relays Rly1, Rly2 for the requirement in steady state. The driving control circuit 24, namely, the second switch unit Q2, the resistors R3, R4 of the bias unit 242, the third switch unit Q3, and the resistor R2 form a mechanism for altering the configuration of the excitation coils of relays. Together with the driving signal Vdr and the control signal Vps, the purposes of driving excitation in transients and maintaining at lowered voltage in steady states.

First, as the assumption in the previous embodiment, before driving, the driving signal Vdr and the control signal Vps are maintained at low voltage level. Thereby, the first, second, and third switch units Q1, Q2, Q3 are kept cutoff until the driving signal Vdr and the control signal Vps are turned to the high level. At this time, the first and second switch units Q1, Q3 are turned on. Besides, because the second terminal of the third switch unit Q3 is connected with the resistor R4 of the bias unit 242, the low voltage level at the second terminal of the third switch unit Q3 during the on state drives the second switch unit Q2 to turn on as well. Due to the relation of parallel circuitry, it is deduced that the coil voltage of the first relay Rly1 is equal to the driving voltage Vdd minus the saturation voltage Vce(sat) of the third switch unit Q3. If the saturation voltage is ignored, it is known that the coil voltage of the first relay Rly1 is equal to the driving voltage Vdd. Likewise, because the second and first switch units Q2, Q1 are turned on, the coil voltage of the second relay Rly2 is equal to the driving voltage Vdd minus the saturation voltages of the second and first switch units Q2, Q1 Vec(sat) and Vce(sat). By ignoring the saturation voltages, the coil voltage of the second relay Rly2 is equal to the driving voltage Vdd. Thereby, at this stage, the coils of the first and second relays Rly1, Rly2 are equivalent to be parallel with the driving voltage Vdd. The driving voltage Vdd at least must be greater than the threshold voltage for driving, namely, the voltage sufficient to excite the coils and close the reed. After the relays Rly1, Rly2 are excited and the reeds are closed, the control signal Vps will change from the high voltage level to the low. The third switch unit Q3 will be cut off accordingly. By choosing appropriate resistors R3, R4 of the bias unit 242, the second switch unit Q2 can be cut off as soon as the third switch unit Q3 is cut off. Thereby, the coils of the relays Rly1, Rly2 recover to the serial circuitry state from the parallel circuitry one. At this time, the driving voltage Vdd will be uniformly distributed to the oil voltages of the relays Rly1, Rly2. Taking the present embodiment for example, the coil voltages of the relays Rly1, Rly2 will be equal to a half of the driving voltage Vdd. Ensuring this voltage greater than the minimum holding voltage of the relays can keep the contacts closed. By lowering the steady-state voltage of the coils, the power consumption of the relays Rly1, Rly2 can be reduced. Accordingly, the temperature of the relays Rly1, Rly2 is reduced and hence enhancing their lifetime and reliability.

As shown in FIG. 2B, the phase of the driving signal Vdr of the switching control circuit with respect to the control signal Vps of the driving control signal is displayed.

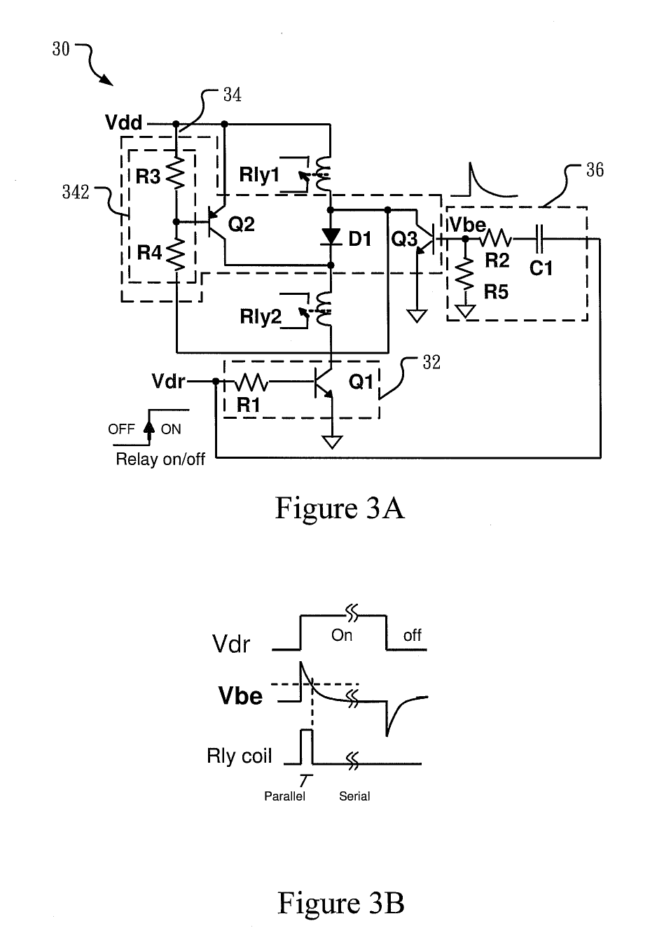

FIGS. 3A and 3B show a circuit diagram and a waveform diagram according to another embodiment of the present invention. The difference between FIG. 2A and FIG. 3A is that the third switch unit Q3 in FIG. 2A is coupled to the control signal Vps via the resistor R2, while the third switch unit Q3 is coupled to a timing control unit 36. As shown in the figures, the driving circuit 30 of the relay according to the present invention comprises a first relay Rly1, a second relay Rly2, a switching control circuit 32, and a driving control circuit 34. The switching control circuit 32 includes a first switch unit Q1 and a resistor R1. The driving control circuit 34 includes a second switch unit Q2, a third switch unit Q3, and a bias unit 342, where the bias unit 342 includes a plurality of resistors R3, R4. The timing control unit 36 includes the capacitor C1 and a plurality of resistors R2, R5. In addition, the driving circuit 30 according to the present embodiment further comprises a first diode D1.

The first relay Rly1, the second relay Rly2, and the switching control circuit 32 according to the present embodiment are the same as the first relay Rly1, the second relay Rly2, and the switching control circuit 22 according to the previous one. Thereby, the connection of the present embodiment will be described again. The driving control circuit is coupled to the first and second relays Rly1, Rly2. The bias unit 342 is coupled to the driving power supply Vdd. A first terminal of the second switch unit Q2 is coupled to the bias unit 342. A second terminal of the second switch unit Q2 is coupled to the driving power supply and the first relay Rly1. A third terminal of the second switch unit Q2 is coupled to the second relay Rly2 and the cathode of the first diode D1. A first terminal of the third switch unit Q3 is coupled to the timing control unit 36. In other words, the first terminal of the third switch unit Q3 is coupled to the resistors R2, R5 and the capacitor C1 and the capacitor C1 is further coupled to the driving signal Vdr. Thereby, the timing control unit 36 generates a timing control signal according to the driving signal Vdr, which is a base-to-emitter voltage Vbe produced by the resistors R2, R5, for controlling the third switch unit Q3. A second terminal of the third switch unit Q3 is coupled to the first relay Rly1, the cathode of the first diode, and the bias unit 342. A third terminal if the third switch unit Q3 is coupled to the reference voltage. The second and third switch units Q2, Q3 drives the first and second relays Rly1, Rly2 according to the timing control signal to form a serial or parallel circuit.

Moreover, the driving circuit for relay 30 according to the present embodiment is another application of the present invention, which integrates the driving signal Vdr and the control signal Vps. Thereby, the driving circuit for relay 30 according to the present embodiment needs only one driving signal Vdr for achieving the purposes of rapid driving in transients and reducing voltage and maintaining in steady states. The added capacitor C1 in the figure provides a path at early stage of driving for turning on the third and first switch units Q3, Q1 synchronously. AT this time, the coils are equivalently driven in parallel. The coil voltage is Vdd. Then, the driving signal Vdr stores energy to the capacitor C1 via R2 and R5. As the energy increases, the base-to-emitter voltage of the third switch unit Q3 decreases accordingly until the third switch unit Q3 is cut off. As the description above, the second switch unit Q2 will be cut off accordingly. At this moment, the coils of the first and second relays Rly1, Rly2 return to serial driving. By adjusting the capacitance of the capacitor C1, the time the coils returning serial connection from parallel connection can be adjusted.

As shown in FIG. 3B, the phases of the driving signal Vdr of the switching control circuit, the voltage Vbe of the first terminal of the third switch unit Q3 to the reference level, and the coil voltage Vcoil are displayed.

According to the above embodiment, at the early stage, the relays use a higher driving voltage, namely, Vdd, to excite the coils of the relays rapidly and thus making the reeds thereof close immediately. Then, by taking advantage of the property of serial excitation coils of the relays, the driving voltage is divided uniformly and lowering the excited coil voltage. The driving circuit for relay as described above takes the coils of two relays connected in series as an example. However, the present invention is not limited to this example. This invention also applies to coils of more relays connected in series. The coil voltage at steady states can be reduced effectively. In the above embodiment, the coil voltage is reduced to a half of the driving voltage Vdd. If the excitation coil can be represented by a resistor R, the power consumption of the coil of an excited relay is Vdd²/R. If the coil voltage of an excited relay is lowered to a half of the driving voltage, the power consumption can be reduced to a quarter of the original power consumption, thus significantly reducing the temperature of the coil. Accordingly, the present invention has the advantage of reducing the power consumption of relays and the system, lowering the operating temperature of the coils of relays, and enhancing the lifetime of relays. In addition, it is not required to dispose another set of voltage holding circuit, which needs cost. Extra controller for producing high-frequency driving circuitry is not required, either.

According to the above embodiments, two relays Rly1, Rly2 are used as an example. Nonetheless, the present invention is not limited to the example. The number of relays can be increased depending the requirements. That is to say, the number of relays can be set to N, which is greater than one. The driving control circuit controls the voltage levels of the coils of the plurality of relays. At the turn-on transient, sufficient energy is supplied to the excitation coils to close the reeds. Next, by taking advantage of the principle described above, the coil voltage can drop to one Nth of the driving voltage. Thereby, the purpose of reducing power consumption can be achieved.

To sum up, the present invention provides a driving circuit for relay, which uses the driving control circuit to provide a higher voltage to the serial circuit formed by the coils of the first and second relays, or enables the driving voltage and the coils of the first and second relays to form a parallel circuit. Thereby, the coils of the first and second relays are excited in a very short time, and the voltages of the coils of the first and second relays are reduced subsequently for lowering the power consumption of the coils of the first and second relays. Hence, the temperature of the coils of the first and second relays can be reduced and the lifetime and reliability of the first and second relays can be enhanced.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A driving circuit for relay, comprising:
a plurality of relays, having coils coupled to a power supply, the power supply providing a driving voltage to the coils of the plurality of relays, and the coils of the plurality of relays coupled to each other;
a switching control circuit, coupled to the coils of the plurality of relays and a reference voltage, and controlling on/off of the coils of the plurality of relays according to a driving signal; and
a driving control circuit, coupled to the coils of the plurality of relays, controlling excitation of the coils of the plurality of relays, and controlling the voltage of the coils of the plurality of relays to be greater than or equal to one Nth of the driving voltage, respectively, and to be smaller than or equal to the driving voltage, respectively, where N is the number of the plurality of relays and N is greater than one.

2. The driving circuit for relay of claim 1, wherein the switching control circuit comprises:
a resistor, having a terminal receiving the driving signal; and
a switch unit, having a first terminal coupled to the other terminal of the resistor, a second terminal coupled to the coil of a second relay of the plurality of relays, and a third terminal coupled to the reference voltage.

3. The driving circuit for relay of claim 1, and further comprising:
a first diode, having a terminal coupled to the coil of a first relay of the plurality of relays, the other terminal coupled to the coil of a second relay of the plurality of relays; and
a second diode, having a terminal coupled to the power supply and the driving control circuit, and the other terminal coupled to the coil of the first relay.

4. The driving circuit for relay of claim 1, wherein the driving control circuit comprises:
a capacitor, having a terminal coupled to the coils of the plurality of relays;
a bias unit, coupled to the switching control circuit;
a first switch unit, having a first terminal coupled to the bias unit, a second terminal coupled to the other terminal of the capacitor, and a third terminal coupled to the bias unit; and
a second switch unit, having a first terminal coupled to the bias unit, a second terminal coupled to the power supply, a third terminal coupled between the capacitor and the first switch unit, and the first switch unit and the second switch unit controlling the capacitor to store a driving voltage of the power supply according to the bias unit and the switching control unit for combining the driving voltage supplied by the power supply and controlling the voltage of the coils of the plurality of relays to be greater than or equal to one Nth of the driving voltage and smaller than or equal to the driving voltage, respectively.

5. The driving circuit for relay of claim 4, wherein the bias unit comprises:
a first resistor, having a terminal coupled to the switching control circuit;
a second resistor, having a terminal coupled to the other terminal of the first resistor, the first terminal of the first switch unit coupled between the first resistor and the second resistor, and the other terminal of the second resistor coupled to the reference voltage; and
a third terminal, having a terminal coupled to a terminal of the first resistor, and the other terminal coupled to the first terminal of the second switch unit.

6. The driving circuit for relay of claim 1, wherein the driving control circuit comprises:
a bias unit, coupled to the power supply;
a first switch unit, having a first terminal coupled to the bias unit, a second terminal coupled to the power supply and a first relay of the plurality of relays, and a third terminal coupled to a terminal of a second relay of the plurality of relays; and
a second switch unit, having a first terminal coupled to a control signal, a second terminal coupled to the other terminal of the first relay and the bias unit, a third terminal coupled to the reference voltage, and the first switch unit and the second switch unit enabling the coils of the first and second relays to form a serial or parallel circuit according to the control signal and controlling the voltage of the coils of the plurality of relays to be greater than or equal to one Nth of the driving voltage and smaller than or equal to the driving voltage, respectively.

7. The driving circuit for relay of claim 6, wherein the bias unit comprises:
a first resistor, having a terminal coupled to the power supply; and
a second resistor, having a terminal coupled to a terminal of the first resistor, the first terminal of the first switch unit coupled between the first and second resistors, and the other terminal of the second resistor coupled to the second terminal of the second switch unit.

8. The driving circuit for relay of claim 6, and further comprising a diode, having a terminal coupled to the coil of the first relay and the second terminal of the second switch unit, and the other terminal coupled to the coil of the second relay.

9. The driving circuit for relay of claim 1, wherein the driving control circuit further comprises:
a bias unit, coupled to the power supply;
a first switch unit, having a first terminal coupled to the bias unit, a second terminal coupled to the power supply and the coil of a first relay of the plurality of relays, and a third terminal coupled to the coil of a second relay of the plurality of relays;
a timing control unit, coupled to the switching control circuit, and generating a timing control signal according to the driving signal; and
a second switch unit, having a first terminal coupled to the timing control unit, a second terminal coupled to the coil of the first relay and the bias unit, a third terminal coupled to the reference voltage, and the first switch unit and the second switch unit enabling the coils of the first and second relays to form a serial or parallel circuit according to the timing control signal and controlling the voltage of the coils of the plurality of relays to be greater than or equal to one Nth of the driving voltage and smaller than or equal to the driving voltage, respectively.

10. The driving circuit for relay of claim 9, wherein the bias unit comprises:
a first resistor, having a terminal coupled to the power supply; and
a second resistor, having a terminal coupled to a terminal of the first resistor, the first terminal of the first switch unit coupled between the first and second resistors, and the other terminal of the second resistor coupled to the second terminal of the second switch unit.

11. The driving circuit for relay of claim 9, wherein the timing control unit comprises:
a capacitor, having a terminal receiving the driving signal;
a first resistor, having a terminal coupled to the first terminal of the second switch unit, and coupled to the other terminal of the capacitor; and
a second resistor, having a terminal coupled to a terminal of the first resistor, and the other terminal coupled to the reference voltage.

12. The driving circuit for relay of claim 9, further comprising:
a diode, having a terminal coupled to the other terminal of the first relay and the second terminal of the second switch unit, and the other terminal coupled to a terminal of the second relay.
